(19) United States
(12) Patent Application Publication
(10) Pub. No.: US 2013/0033859 A1
(43) Pub. Date: Feb. 7, 2013

(54) LED-BASED LIGHTING UNIT

(71) Applicants: Howard Irwin Yaphe, Quebec (CA); Gary Eugene Schaefer, Kitchener (CA)

(72) Inventors: Howard Irwin Yaphe, Quebec (CA); Gary Eugene Schaefer, Kitchener (CA)

(73) Assignee: Koninklijke Philips Electronic, N.V., Eindhoven (NL)

(21) Appl. No.: 13/641,138

(22) PCT Filed: Apr. 20, 2011
(86) PCT No.: PCT/IB11/51724

§ 371 Date: Oct. 15, 2012

Related U.S. Application Data
(60) Provisional application No. 61/327,401, filed on Apr. 23, 2010.

(51) Int. Cl. F21V 13/04

(52) U.S. Cl. 362/223

(57) ABSTRACT

The present disclosure is directed to inventive methods and apparatus for a lighting unit having a plurality of substantially linearly arranged solid state light sources (34, 134, 234, 334). A first reflector (40, 140, 240, 340) and a second reflector (50, 150, 250, 350) flank the solid state light sources (34, 134, 234, 334). A lens (60, 160, 260, 360) is provided over and spaced apart from a plurality of the solid state light sources (34, 134, 234, 334).

### TECHNICAL FIELD

The present invention is directed generally to a lighting unit having a plurality of substantially linearly arranged solid state light sources. More particularly, various inventive methods and apparatus disclosed herein relate to a lighting unit having a plurality of linearly arranged LEDs, a first and second reflector flanking the LEDs, and a lens provided over and spaced apart from the LEDs.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications.

Many lighting fixtures have been designed that implement LEDs to reap one or more of the advantages and benefits of LEDs. For example, some lighting fixtures have been designed that implement a plurality of LEDs, with each individual LED having an associated LED optic thereover. For example, each individual LED may have an individual reflector that surrounds the LED and reflects light output from the LED into a desired beam distribution and an associated individual lens coupled to the reflector that refracts light output from the LED in a desired direction. The LEDs may be appropriately positioned and each LED optic may be appropriately paired with a desired of the LEDs in order to obtain a desired light output from the lighting fixture. While such lighting fixtures generally enable a desired light output to be obtained, they may cause individual imaging of each optic on the target illumination area, thereby causing a non-uniform illumination pattern. Likewise, such lighting fixtures may employ fixed, unremovable LED optics, thereby preventing the lighting fixtures from being easily adapted to provide a selected of a plurality of distinct optical outputs.

Thus, there is a need in the art for a lighting unit having a plurality of solid state light sources (e.g., LEDs), which has reduced imaging of individual LED optics on the target illumination area and which can provide a plurality of distinct optical outputs.

### SUMMARY

The present disclosure is directed to inventive methods and apparatus for a lighting unit having a plurality of substantially linearly arranged solid state light sources such as, for example, LEDs. More particularly, various inventive methods and apparatus disclosed herein relate to a lighting unit having a plurality of linearly arranged LEDs, a first and second reflector flanking the LEDs, and a lens provided over and spaced apart from the LEDs. Optionally, the lens may be removably coupled over the LEDs, thereby allowing for interchanging with a lens having alternative optical characteristics. For example, a lens that has optical characteristics that provide for a spot target narrow distribution may be interchanged with a lens that provides for a distinct linear spot target distribution. The lens may be formed from a single longitudinally extending piece or may include a plurality of lens pieces. For example, the lens may include a plurality of longitudinally extending lens pieces and/or a plurality of non-longitudinally extending lens pieces that collectively form a longitudinally extending lens. Each lens piece may be provided over a single or multiple of the LEDs. The lighting unit may optionally be designed to enable the orientation of the LEDs to be selectively adjustable by a user. The present disclosure may provide a LED lighting unit that may be manipulated by a user (e.g., by changing out the lens and/or adjusting the orientation of the LEDs) to provide a desired optical output from the LED light unit, thereby allowing for a variety of lighting configurations from the lighting unit.

Generally, in one aspect, a LED-based lighting unit is provided that includes a plurality of substantially linearly arranged LEDs, a longitudinally extending first reflector, and a longitudinally extending second reflector. The longitudinally extending first reflector is along a first side of the LEDs and has a first generally concave reflective surface extending outward and away from adjacent the LEDs. The longitudinally extending second reflector is along a second side of the LEDs and has a second generally concave reflective surface extending outward and away from adjacent the LEDs. The lens is provided over and spaced apart from a plurality of the LEDs and extends between the first reflector and the second reflector. The lens is removably coupled over the LEDs.

In some embodiments the lens has a substantially planar first side facing the LEDs and a non-planar second side opposite the first side. In some versions of those embodiments the first concave reflective surface and the second concave reflective surface have substantially similar concavities. In some versions of those embodiments the first concave reflective surface extends outward a first distance from the LEDs and the second concave reflective surface extends outward a second distance from the LEDs; the second distance being at least one and a half times the first distance. In some versions of those embodiments the first concave reflective surface extends away from the LEDs approximately the same distance as the second concave reflective surface.

In some embodiments the lens is removably coupled to the first reflector and the second reflector.

In some embodiments the lens is a singular longitudinally extending piece provided over each of the plurality of LEDs.

In some embodiments the lens includes a plurality of adjacent individual lens pieces. In some versions of those embodiments each of the individual lens pieces is provided over a single of the LEDs.

Generally, in another aspect a LED-based lighting unit includes a support surface, a plurality of LEDs, a longitudinally extending first reflector, a longitudinally extending second reflector, and a lens. The plurality of LEDs are coupled to the support surface in a substantially linear arrangement. The longitudinally extending first reflector is coupled to the support surface on a first side of the LEDs and has a first generally concave reflective surface extending outward and away from adjacent the LEDs. The longitudinally extending second reflector is along a second side of the LEDs and has a second generally concave reflective surface extending outward and away from adjacent the LEDs. The lens is provided over and spaced apart from each of the LEDs. The lens extends between the first reflector and the second reflector and has a substantially planar first side facing the LEDs and a non-planar second side opposite the first side.

In some embodiments the lens is removably coupled over the LEDs. In some versions of those embodiments the lens is removably coupled to the first reflector and the second reflector.

In some embodiments the lens includes at least one longitudinally extending lens piece provided over each of the plurality of LEDs. In some versions of those embodiments the lens includes two the longitudinally extending lens piece, each the lens piece provided over at least a portion of each of the plurality of LEDs.

In some embodiments the lens includes a plurality of lens pieces. In some versions of those embodiments each of the lens pieces is provided over a single of the LEDs.

In some embodiments the support surface is repositionable to a plurality of user selectable orientations.

Generally, in another aspect A LED-based lighting unit system includes a plurality of LEDs, a longitudinally extending first reflector, a longitudinally extending second reflector, and a plurality of lens having unique optical characteristics. The LEDs are substantially linearly arranged and the first reflector and the second reflector flank the LEDs. The first reflector has a first reflective surface extending outward and away from adjacent the LEDs. The second reflector has a second reflective surface extending outward and away from adjacent the LEDs. Each lens may be removably coupled over and spaced apart from a plurality of the LEDs and extend between the first reflector and the second reflector.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). It should also be understood that the term LED does not limit the physical and/or electrical package type of an LED.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a bottom front exploded perspective view of a first embodiment of a lighting unit.

FIG. 2 illustrates a rear plan view of the first embodiment of the lighting unit.

FIG. 3 illustrates a section view of the first embodiment of the lighting unit taken along the section line 3-3 of FIG. 2.

FIG. 4 illustrates a bottom front exploded perspective view of a second embodiment of a lighting unit.

FIG. 5 illustrates a front plan view of the second embodiment of the lighting unit.

FIG. 6 illustrates a section view of the second embodiment of the lighting unit taken along the section line 6-6 of FIG. 5.

FIG. 7 illustrates a bottom front exploded perspective view of a third embodiment of a lighting unit.

FIG. 8 illustrates a front plan view of the third embodiment of the lighting unit.

FIG. 9 illustrates a section view of the third embodiment of the lighting unit taken along the section line 9-9 of FIG. 8.

### DETAILED DESCRIPTION

In the following detailed description, for purposes of explanation and not limitation, representative embodiments disclosing specific details are set forth in order to provide a thorough understanding of the claimed invention. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the claimed invention. For example, various embodiments of the apparatus disclosed herein are particularly suited for installation in a ceiling grid, such as, for example, a ceiling grid employing a low-voltage ceiling grid power supply system. Accordingly, for illustrative purposes, the claimed invention is discussed in conjunction with a lighting unit that may be adapted for such installation. However, other configurations and applications of the apparatus are contemplated without deviating from the scope or spirit of the claimed invention.

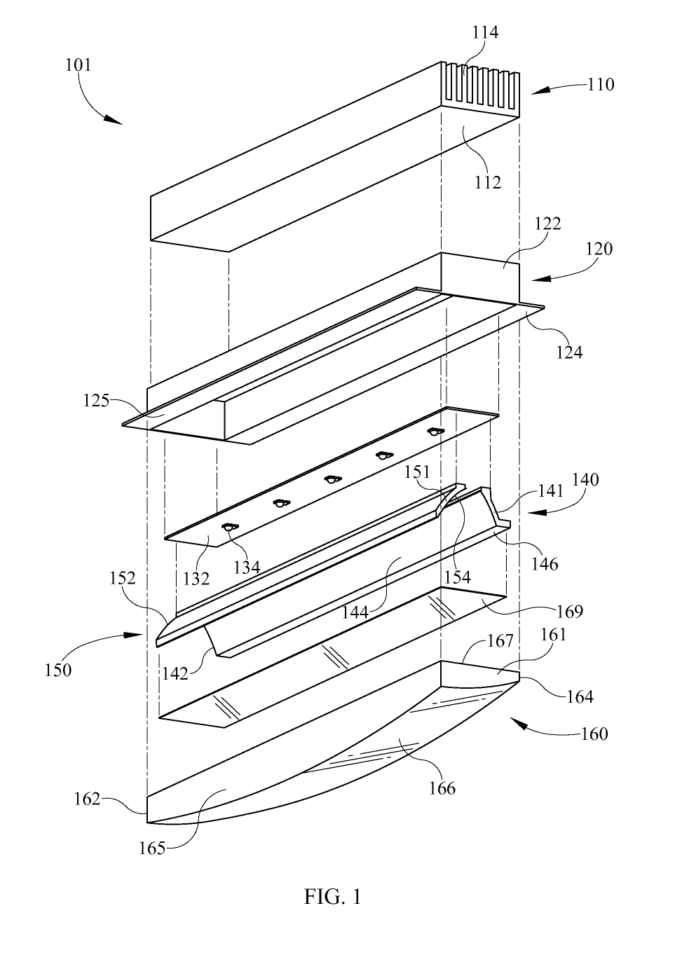

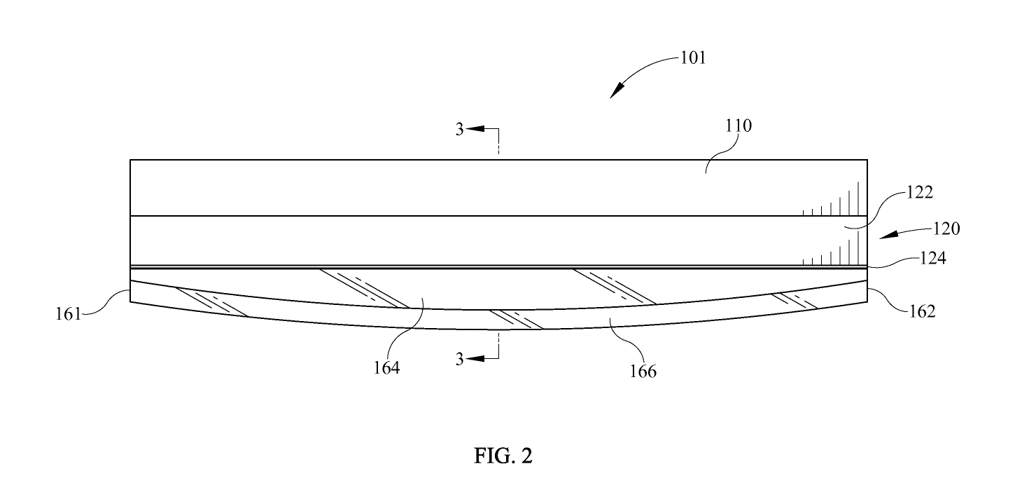

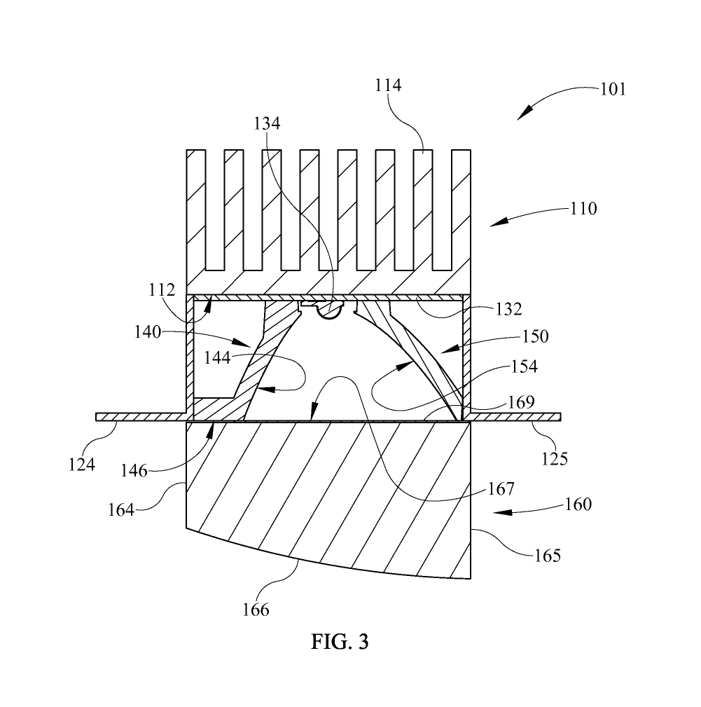

Referring initially to FIG. 1 through FIG. 3, a first embodiment of a lighting unit 110 is shown. The lighting unit 110 has a plurality of LEDs 134 mounted in a linear arrangement on a circuit board 132. The circuit board 132 may be coupled to a support surface 112 of a heatsink 110. A plurality of heat fins 114 extend rearwardly from the support surface of the heatsink 110 and assist in dissipation of heat generated by the LEDs 134. Optionally, a thermal material (e.g., thermal paste and/or a thermal pad) may be interposed between the circuit board 132 and the support surface 112. In alternative embodiments the LEDs 134 may each be mounted on individual circuit boards or may be mounted directly to the support surface 112.

A longitudinally extending first reflector 140 is provided along a first side of the LEDs 134. The first reflector 140 is a singular piece and extends longitudinally from a first end 141 to a second end 142 thereof along each of the LEDs 134. In alternative embodiments the first reflector 140 may comprise multiple reflector pieces and/or may extend along less than all of the LEDs 134. The first reflector 140 has an inner concave surface 144 that extends from adjacent the LEDs 134 in a direction outward and away from the LEDs 134 toward a flange 146 of the first reflector 140. The away direction is the direction generally perpendicular to the surface on which the LEDs 134 are mounted. In other words, in the first embodiment of the lighting unit 10 the away direction is generally perpendicular to the surface of the circuit board 132 to which the LEDs 134 are mounted. The outward direction is the direction peripheral of the LEDs 134. In other words, the outward direction is generally perpendicular to the away direction.

A longitudinally extending second reflector 150 is provided along a second side of the LEDs 134. The second reflector 150 is a singular piece and extends longitudinally from a first end 151 thereof to a second end 152 thereof along each of the LEDs 134. In alternative embodiments the second reflector 150 may comprise multiple reflector pieces and/or may extend along less than all of the LEDs 134. The second reflector 150 has an inner concave surface 154 that extends from adjacent the LEDs 134 in a direction outward and away from the LEDs 134. The inner concave surface 154 and the inner concave surface 144 extend away from the LEDs 134 approximately the same distance. However, the inner concave surface 154 extends outward from the LEDs 134 approximately twice the distance as the inner concave surface 144. Accordingly, the inner concave surface 154 has a greater degree of curvature than the inner concave surface 144.

First reflector 140 and/or second reflector 150 may, in some embodiments be coupled to the circuit board 132. For example, in some embodiments the first reflector 140 and/or the second reflector 150 may be fixedly or removably coupled to the circuit board 132 using mechanical affixation methods, including, but not limited to adhesives, welding, soldering, prongs, fasteners, and/or structure that may extend from first reflector 140, second reflector 150, and/or circuit board 132. In some other embodiments the first reflector 140 and/or the second reflector 150 may be coupled to a frame 120 using mechanical affixation methods. The frame 120 may be coupled to the heatsink 110 and includes a frame sidewall 122 that surrounds the first reflector 140, the second reflector 150, the LEDs 134, and the circuit board 132. A first flange 124 and a second flange 125 extend perpendicular to and peripherally of the frame sidewall 122 and are substantially co-planar with the edges of first reflector 140 and second reflector 150 that are distal the circuit board 132. The frame 120 may be relatively small in some embodiments such as, for example, five inches in longitudinal length and one inch in latitudinal width. Optionally, the lighting unit 10 may be adapted to be attached to a ceiling grid such as, for example, a low voltage powered ceiling grid system currently being advanced by the Emerge Alliance.

A longitudinally extending lens 160 is provided over and spaced apart from the LEDs 134. The lens 160 may be constructed from a proper optical medium. For example, in some embodiments the lens 160 may be molded optical grade acrylic. The lens 160 is longitudinally extending from a first end 161 thereof to a second end 162 thereof. A substantially planar first side 167 of the lens 160 extends between the first end 161 and second end 162 and faces the LEDs 134. The first side 167 is substantially co-planar with the circuit board 132. A non-planar second side 166 is provided opposite the first side 167 and extends between the first end 161 and the second end 162. A front longitudinal side 165 and a rear longitudinal side 164 extend between the first side 167 and the second side 166. The rear longitudinal side 164 and the front longitudinal side 165 are oriented substantially perpendicular to the first side 167. The front longitudinal side 165 is taller (in a direction from the first side 167 to the second side 166) than respective longitudinal locations of the rear longitudinal side 164. The lens 160 extends between and beyond the first reflector 140 and the second reflector 150. The lens 160 may be coupled to the flange 146, the edge of the second reflector 150, and/or portions of the frame utilizing an adhesive, for example. In other embodiments the lens 160 may be coupled to the first reflector 140, the second reflector 150, and/or the frame 120 using alternative mechanical affixation methods, including, but not limited to welding, soldering, prongs, fasteners, and/or structure that may extend from first reflector 140, second reflector 150, and/or circuit board 132. Optionally, the mechanical affixation methods may allow for the lens 160 to be removably coupled to respective structure. A Gaussian filter 169 may optionally extend between the first reflector 140 and the second reflector 150 and be interposed between the LEDs 134 and the lens 160.

In operation, appropriate electrical connections (e.g. from a LED driver and/or a low voltage ceiling grid) may be made to LEDs 134. Some light output from LEDs 134 will be directly incident on Gaussian filter 169 and then lens 160. Some light output will first reflect off first reflector 140, second reflector 150, and/or an interior facing portion of frame sidewall 122 and redirected toward filter 169 and then lens 160. The first reflector 140, second reflector 150, and the lens 160 are configured for wall washing. A majority of the light emitted from the LEDs 134 will be directed out front longitudinal side 165 and second side 166 and directed generally toward an area that is in a direction that front longitudinal side 165 faces. As will be understood by one of ordinary skill in the art, having had the benefit of the present disclosure, variations may be made to the first reflector 140, second reflector 150, and or lens 160 to achieve a desired light output that varies from the light output achieved by lighting unit 110. For example, in some embodiments the degree of curvature of the first concave surface 144 may be decreased to increase forward throw of light output and/or the contour of second surface 166 may be altered to achieve a different amount of internal reflection and/or different characteristics of internal reflection.

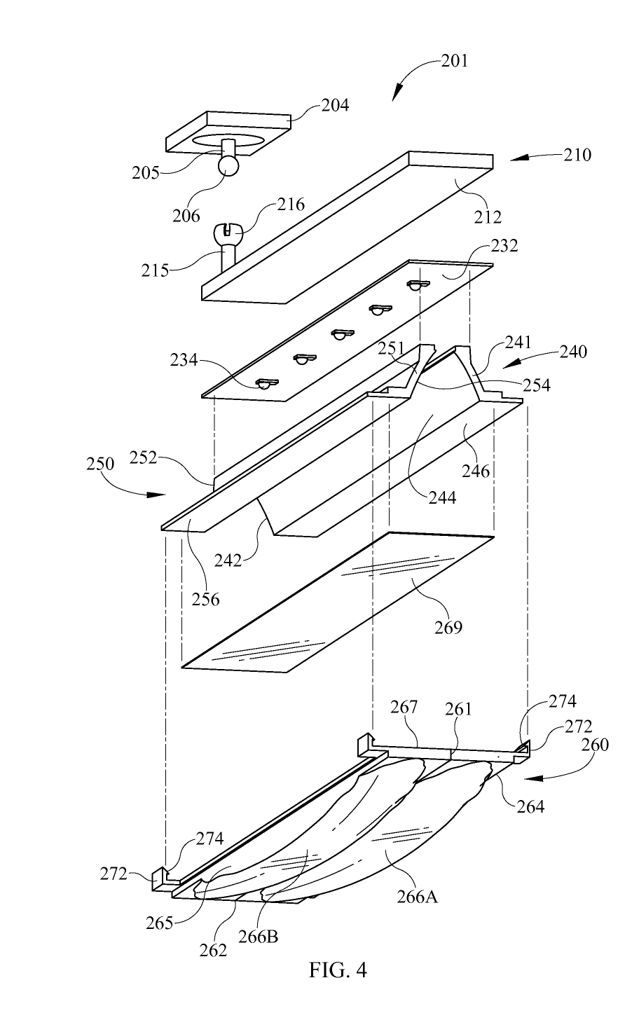

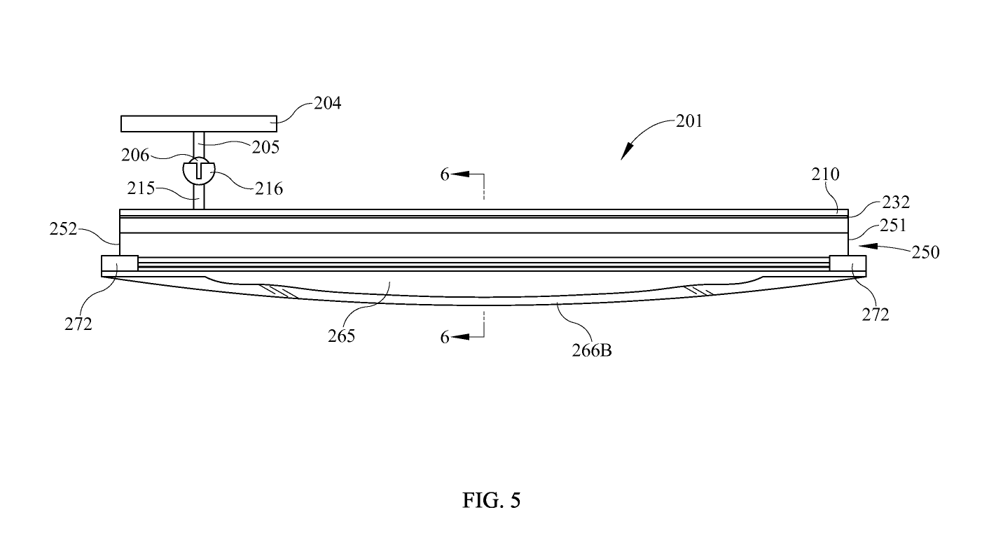

Referring to FIG. 4 through FIG. 6, a second embodiment of a lighting unit 210 is shown. The lighting unit 210 has a plurality of LEDs 234 mounted in a linear arrangement on a circuit board 232. The circuit board 232 may be coupled to a support surface 212 of a heatsink 210. Optionally, a thermal material (e.g., thermal paste and/or a thermal pad) may be interposed between the circuit board 232 and the support surface 212. In alternative embodiments the LEDs 234 may be mounted directly to the support surface 212. The heatsink 210 has a ball socket shaft 215 extending from a rear surface thereof that is coupled to a ball socket 216. The ball socket 216 is movably coupleable to a ball 206 that is coupled to a ball shaft 205 extending from an attachment piece 204. The attachment piece 204 may be configured for installation in a ceiling grid such as, for example, a low voltage powered ceiling grid system. The movable coupling between the ball 206 and ball socket 216 enables the heatsink 210 and the attached circuit board 232 to be movably positioned at a desired orientation by a user. In alternative embodiments one or more hinges may be utilized in lie of the ball 206 and ball socket 216 to enable circuit board 232 to be movably positioned at a desired orientation by a user.

A longitudinally extending first reflector 240 is provided along a first side of the LEDs 234. The first reflector 240 is a singular piece and extends longitudinally from a first end 241 to a second end 242 thereof along each of the LEDs 234. In alternative embodiment the first reflector 240 may comprise multiple reflector pieces and/or may extend along less than all of the LEDs 234. The first reflector 240 has an inner concave surface 244 that extends from adjacent the LEDs 234 in a direction outward and away from the LEDs 234 toward a flange 246 of the first reflector 240.

A longitudinally extending second reflector 250 is provided along a second side of the LEDs 234. The second reflector 250 is a singular piece and extends longitudinally from a first end 251 thereof to a second end 252 thereof along each of the LEDs 234. In alternative embodiments the second reflector 250 may comprise multiple reflector pieces and/or may extend along less than all of the LEDs 234. The second reflector has an inner concave surface 254 that extends from adjacent the LEDs 234 in a direction outward and away from the LEDs 234 toward a flange 256 of the second reflector 250. The inner concave surface 254 and the inner concave surface 244 share a substantially common degree of curvature and extend away from the LEDs 234 approximately the same distance and outward from the LEDs 234 approximately the same distance.

First reflector 240 and/or second reflector 250 may, in some embodiments be coupled to circuit board 232. For example, in some embodiments the first reflector 240 and/or the second reflector 250 may be coupled to the circuit board 232 using mechanical affixation methods. In some other embodiments the first reflector 240 and/or the second reflector 250 may be coupled to the heatsink 210 using mechanical affixation methods. Although not depicted, an end plate may optionally be placed between first ends 241 and 251 of first and second reflectors 240 and 250 and/or second ends 242 and 252 of first and second reflectors 240 and 250. The end plate may optionally be interiorly reflective or semi-reflective.

A longitudinally extending lens 260 is provided over and spaced apart from the LEDs 234. The lens 260 is longitudinally extending from a first end 261 thereof to a second end 262 thereof. A substantially planar first side 267 of the lens 260 extends between the first end 261 and second end 262 and faces the LEDs 234. The first side 267 is substantially co-planar with the circuit board 232. A non-planar second side includes a first protruding portion 266A and a second protruding portion 266B that are substantially similar in shape, are provided opposite the first side 267, and extend between the first end 261 and the second end 262. A front longitudinal side 265 and a rear longitudinal side 264 extend between the first end 261 and the second end 262. The front longitudinal side 265 and the rear longitudinal side 261 are substantially perpendicular to the first side 267. The first protruding portion 266A and the second protruding portion 266B are substantially basin shaped. The distance between the outer surface of each protruding portion 266A and 266B and the first side 267 decreases when moving longitudinally (e.g., along longitudinal side 264 or 265) or latitudinally (e.g., along first end 261 or second end 262) from the longitudinal and latitudinal center point of each protruding portion 266A and 266B.

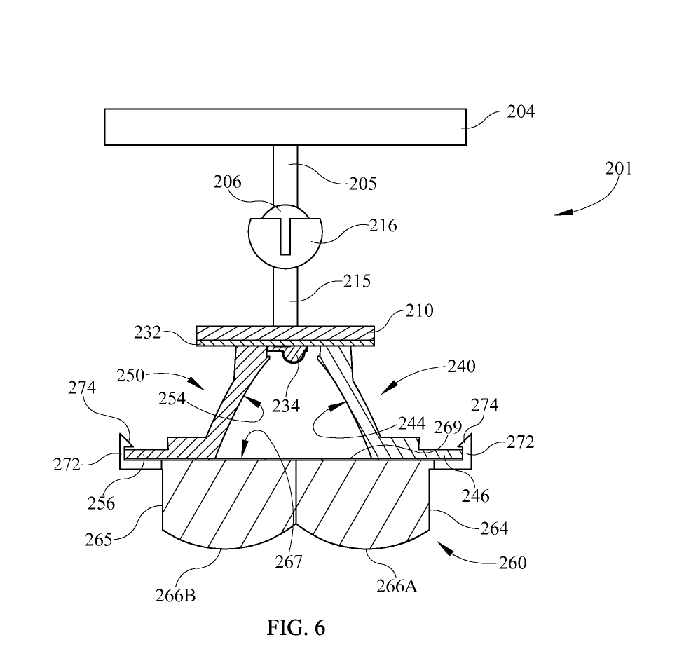

The lens 260 extends between and beyond the inner concave surfaces 244 and 254. In some embodiments the lens 260 may optionally comprise a first longitudinally extending lens having the first protruding portion 266A and a second longitudinally extending lens having the second protruding portion 266B. A Gaussian filter 269 may optionally extend between the first reflector 240 and the second reflector 250 and be interposed between the LEDs 234 and the lens 260. The lens 260 has four attachment legs 272 extending from the lens generally in a direction away from the protruding portions 266A and 266B. The attachment legs 272 are provided on each corner of the lens 260 and have a chamfered locking protrusion 274 extending therefrom. Lens 260 may be coupled to first and second reflectors 240 and 250 by engaging the chamfered locking protrusions 274 against respective of flanges 246 and 256, thereby causing the attachment legs 272 to be forced outward until the chamfered locking protrusions 274 lock with respective of flanges 246 and 256 as depicted in FIG. 6. The lens 260 may be removed from the first and second reflectors 240 and 250 by forcing the locking protrusions 274 outward by a hand, tool, or otherwise, and pulling the lens 260 away from the first and second reflectors 240 and 250. The lens 260 may be interchanged with another lens having alternative optical characteristics (e.g., lens 160) and optionally having similar attachment legs.

In operation, the LEDs 234 may be electrically coupled to a power source. Some light output from LEDs 234 will be directly incident on Gaussian filter 269 and then lens 260. Some light output will first reflect off first reflector 240, second reflector 250, and/or an interior facing portion of one or more endplates and redirected toward filter 269 and then lens 260. The first reflector 240, second reflector 250, and the lens 260 are configured for a square target medium distribution. The light output may be directed in substantially a batwing distribution pattern. A majority of the light emitted from the LEDs 234 will be directed out first protruding portion 266A and second protruding portion 266B and directed generally toward an area in a direction that first protruding portion 266A and second protruding portion 266B face. As will be understood by one of ordinary skill in the art, having had the benefit of the present disclosure, variations may be made to the first reflector 240, second reflector 250, and or lens 260 to achieve a desired light output that varies from the light output achieved by lighting unit 210.

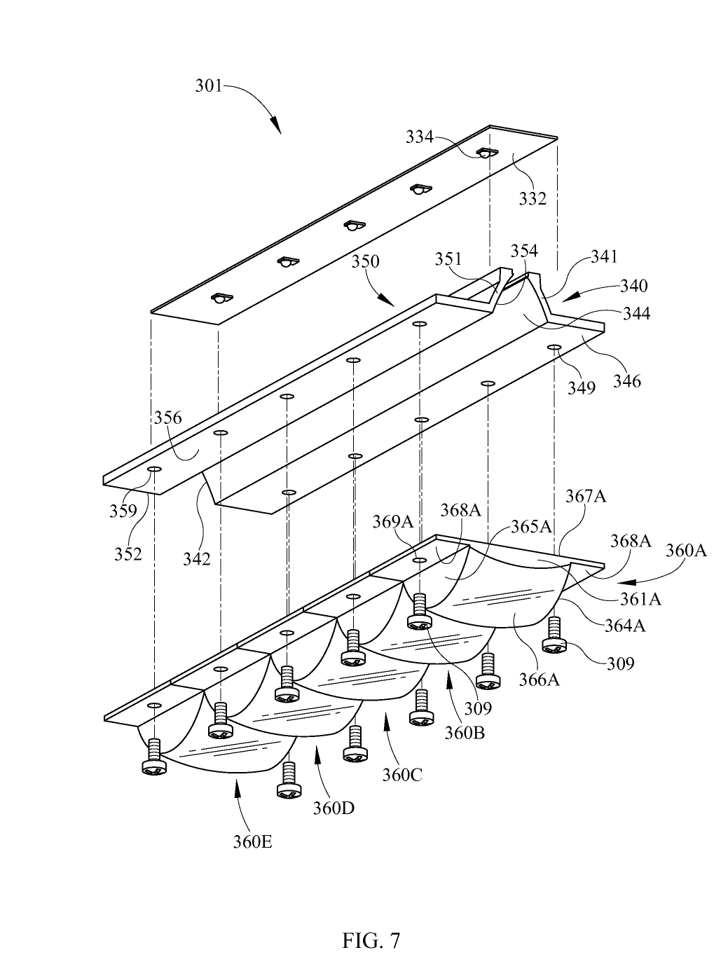

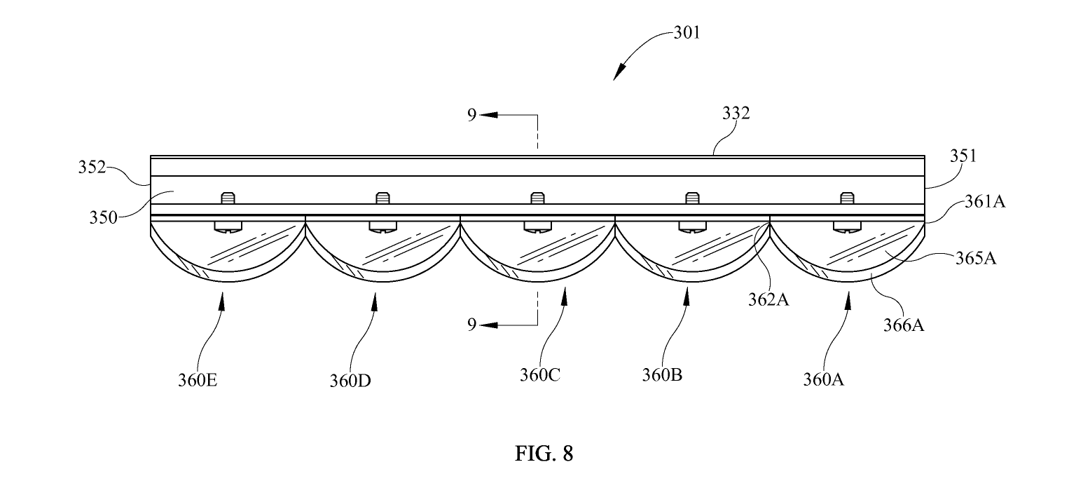

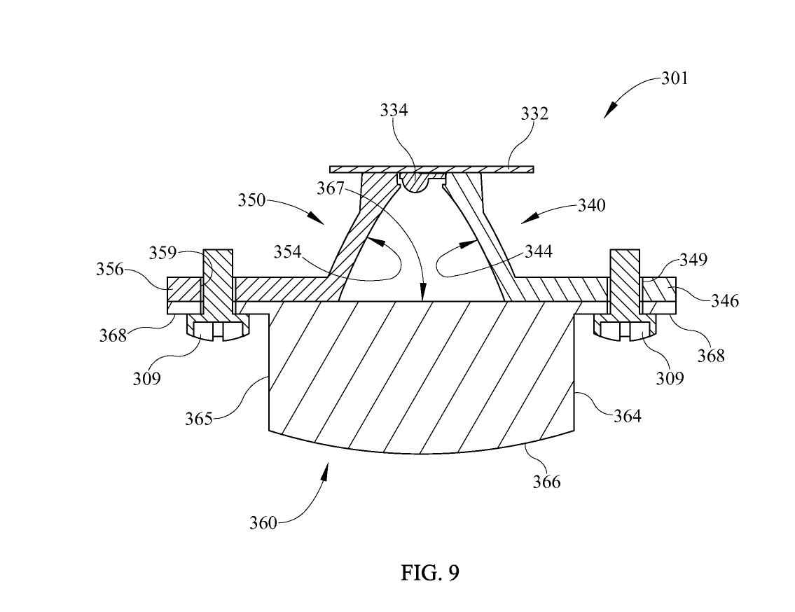

Referring to FIG. 7 through FIG. 9, a third embodiment of a lighting unit 310 is shown. The lighting unit 310 has a plurality of LEDs 334 mounted in a linear arrangement on a circuit board 332. The circuit board 332 may optionally be coupled to a heatsink or other support surface. A longitudinally extending first reflector 340 is provided along a first side of the LEDs 334. The first reflector 340 is a singular piece and extends longitudinally from a first end 341 to a second end 342 thereof along each of the LEDs 334. In alternative embodiment the first reflector 340 may comprise multiple reflector pieces and/or may extend along less than all of the LEDs 334. The first reflector 340 has an inner concave surface 344 that extends from adjacent the LEDs 334 in a direction outward and away from the LEDs 334 toward a flange 346 of the first reflector 340. The flange 346 has a plurality of threaded apertures 349 extending therethrough.

A longitudinally extending second reflector 350 is provided along a second side of the LEDs 334. The second reflector 350 is a singular piece and extends longitudinally from a first end 351 thereof to a second end 352 thereof along each of the LEDs 334. In alternative embodiments the second reflector 350 may comprise multiple reflector pieces and/or may extend along less than all of the LEDs 334. The second reflector has an inner concave surface 354 that extends from adjacent the LEDs 334 in a direction outward and away from the LEDs 334 toward a flange 356 of the second reflector 350. The flange 356 has a plurality of threaded apertures 359 extending therethrough. The inner concave surface 354 and the inner concave surface 344 share a substantially common degree of curvature and extend away from the LEDs 334 approximately the same distance and outward from the LEDs 334 approximately the same distance. The inner concave surface 354 and the inner concave surface 344 also share a substantially common degree of curvature wither inner concave surfaces 244 and 254 of the lighting unit 310.

First reflector 340 and/or second reflector 350 may, in some embodiments be coupled to circuit board 332. For example, in some embodiments the first reflector 340 and/or the second reflector 350 may be coupled to the circuit board 332 using mechanical affixation methods. Although not depicted, an end plate may optionally be placed between first ends 341 and 351 of first and second reflectors 340 and 350 and/or second ends 342 and 352 of first and second reflectors 340 and 350. The end plate may optionally be interiorly reflective or semi-reflective.

A longitudinally extending lens 360 is provided over and spaced apart from the LEDs 334. The lens 360 includes five individual lens pieces 360A-E placed adjacent one another in a longitudinal relationship. The lens 360 is longitudinally extending from lens 360A thereof to lens 360E thereof. Each of the individual lens pieces 360A-E share a common configuration and are placed over a single of the LEDs 334. For ease and clarity in description, individual lens piece 360A is the only of the individual lens pieces 360A-E that is numbered in additional detail in the Figures and that will be described in additional detail herein. Individual lens piece 360A is placed over a single of the LEDs 334. A substantially planar first side 367A of the individual lens piece 360A extends between a first end 361A and second end 362A and faces the single of the LEDs 334. The first side 367A is substantially co-planar with the circuit board 332. A non-planar second side 366A has a substantially half-barrel shape, is provided opposite the first side 367A and extends between the first end 361A and the second end 362A. A front longitudinal side 365A and a rear longitudinal side 364A extend between the first side 367A and the second side 366A. The front longitudinal side 365A and the rear longitudinal side 364A are substantially perpendicular to the first side 367A.

A pair of flanges 368A extend peripherally of the rear longitudinal side 364A and front longitudinal side 365A and each have a fastener aperture 369A provided therethrough. The individual lens piece 360A may be coupled to first reflector 340 and second reflector 350 by placing threaded fasteners 309 through fastener apertures 369A and threading the threaded fasteners 309 into respective of the threaded apertures 349 and 359. The individual lens piece 360A may be removed from first reflector 340 and second reflector 350 by unthreading the threaded fasteners 309 from respective of the threaded apertures 349 and 359. The lens 360 may be interchanged with another lens having alternative optical characteristics and optionally having similar apertures for receiving threaded fasteners 309. For example, the lens 360 may be interchanged with lens 160 or lens 260, either of which may optionally incorporate apertures for receiving threaded fasteners 309. One or more individual lens pieces 360A-E may be interchanged with other lens pieces having alternative characteristics and optionally having similar apertures for receiving threaded fasteners 309. In some embodiments a Gaussian filter may optionally be interposed between the LEDs 334 and at least some of the lens 360.

In operation, the LEDs 334 may be electrically coupled to a power source. Some light output from LEDs 334 will be directly incident on the lens 360. Some light output will first reflect off first reflector 340, second reflector 350, and/or an interior facing portion of one or more end plates and redirected toward lens 360. The first reflector 340, second reflector 350, and the lens 360 are configured for a spot target narrow distribution. A majority of the light emitted from the LEDs 334 will be directed out the second sides 366A-E of the individual lens pieces 360A-E and directed generally toward an area generally in a direction that the second sides 366A-E face. As will be understood by one of ordinary skill in the art, having had the benefit of the present disclosure, variations may be made to the first reflector 340, second reflector 350, and or one or more of individual lens pieces 360A-E to achieve a desired light output that varies from the light output achieved by lighting unit 310.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A LED-based lighting unit, comprising:
a plurality of substantially linearly arranged LEDs;
a longitudinally extending first reflector along a first side of said LEDs, said first reflector having a first generally concave reflective surface extending outward and away from adjacent said LEDs;
a longitudinally extending second reflector along a second side of said LEDs, said second reflector having a second generally concave reflective surface extending outward and away from adjacent said LEDs;
a lens provided over and spaced apart from a plurality of said LEDs, said lens atop and extending between said first reflector and said second reflector;
wherein said lens is removably coupled over said LEDs.

2. The lighting unit of claim 1 wherein said lens has a substantially planar first side facing said LEDs and a non-planar second side opposite said first side

3. The lighting unit of claim 1 wherein said lens is removably coupled to said first reflector and said second reflector.

4. The lighting unit of claim 2 wherein said first concave reflective surface and said second concave reflective surface have substantially similar concavities.

5. The lighting unit of claim 2 wherein said first concave reflective surface extends outward a first distance from said LEDs and said second concave reflective surface extends outward a second distance from said LEDs, wherein said second distance is at least one and a half times said first distance.

6. The lighting unit of claim 5 wherein said first concave reflective surface extends away from said LEDs approximately the same distance as said second concave reflective surface.

7. The lighting unit of claim 1 wherein said lens is a singular longitudinally extending piece provided over each of said plurality of LEDs.

8. The lighting unit of claim 1 wherein said lens includes a plurality of adjacent individual lens pieces.

9. The lighting unit of claim 8 wherein each of said individual lens pieces is provided over a single of said LEDs.

10. A LED-based lighting unit, comprising:
a support surface;
a plurality of LEDs coupled to said support surface in a substantially linear arrangement;
a longitudinally extending first reflector coupled to said support surface on a first side of said LEDs, said first reflector having a first generally concave reflective surface extending outward and away from adjacent said LEDs;
a longitudinally extending second reflector along a second side of said LEDs, said second reflector having a second generally concave reflective surface extending outward and away from adjacent said LEDs;
a lens provided over and spaced apart from each of said LEDs, said lens extending between said first reflector and said second reflector, said lens having a substantially planar first side facing said LEDs and a non-planar second side opposite said first side.

11. The lighting unit of claim 10 wherein said lens is removably coupled over said LEDs.

12. The lighting unit of claim 11 wherein said lens is removably coupled to said first reflector and said second reflector.

13. The lighting unit of claim 10 wherein said lens includes at least one longitudinally extending lens piece provided over each of said plurality of LEDs.

14. The lighting unit of claim 13 wherein said lens includes two said longitudinally extending lens piece, each said lens piece provided over at least a portion of each of said plurality of LEDs.

15. The lighting unit of claim 10 wherein said lens includes a plurality of lens pieces.

16. The lighting unit of claim 14, wherein each of said lens pieces is provided over a single of said LEDs.

17. The lighting unit of claim 10 wherein said support surface is repositionable to a plurality of user selectable orientations.

18. A LED-based lighting unit system, comprising:
a plurality of substantially linearly arranged LEDs;
a longitudinally extending first reflector and a longitudinally extending second reflector flanking said LEDs;
said first reflector having a first reflective surface extending outward and away from adjacent said LEDs;
said second reflector having a second reflective surface extending outward and away from adjacent said LEDs;
a plurality of lens each having unique optical characteristics, wherein each said lens may be removably coupled over and spaced apart from a plurality of said LEDs and extend between said first reflector and said second reflector.

19. The lighting unit system of claim 18 wherein said each said lens may be removably coupled to said first reflector and said second reflector.
